(19) United States
(12) Patent Application Publication
(10) Pub. No.: US 2006/0078327 A1
(43) Pub. Date: Apr. 13, 2006

(54) Simple apparatus for quick support and stabilization of a camera or similar instrument, the camera stock

(76) Inventor: Dale Stanley Ellis, Ripon, CA (US)

Correspondence Address: Dale Stanley Ellis, 517 Pecan Drive, Ripon, CA, 95366, US

(21) Appl. No.: 10/961,628

(22) Filed: Oct. 8, 2004

(51) Int. Cl. G03B 17/00

(52) U.S. Cl. 396/421

(57) ABSTRACT

A simple apparatus for quick stabilization and support of a camera or similar instruments is disclosed having a compact design that is inexpensive to manufacture. The ergonomic shape of the apparatus also makes it ambidextrous and can be used from multiple positions. A camera, or any instrument designed to attach to a tripod, is connected to the apparatus; either directly, or through an intermediate device such as a universal ball-head. Several apertures on multiple surfaces facilitate attachment, increasing versatility and adjustability. In the preferred embodiment the apparatus is manufactured through injection molding or extrusion using a durable material such as glass reinforced nylon or various metal alloys, respectively. It is the overall functionality and simplicity that make this apparatus so unique and useful. Furthermore, it is the versatility and inexpensive one piece construction that make this apparatus an ideal mass marketing device for universal ball heads.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the fields of photography and viewing and more specifically to an apparatus for quick stabilization of a camera or similar instruments; particularly the extensive variety of instruments designed to work either hand-held or attached to a tripod. The history of the technology for this invention is the general history of tripods and cameras; and more recently, a range of instruments designed to mount on a tripod.

Cameras have steadily improved over the last hundred years, and with the exception of special application equipment like movie industry cameras, they are very portable and compact devices. One standard of common use cameras now is that they are manufactured with a threaded receiver in the base for mounting on a tripod. This has become such an international standard that basic specifications do not even list “tripod adaptability” for many cameras. More recently, many other types of instruments are manufactured with the threaded receiver as well including; the video camera, binocular, spotting scope, and night vision scope.

Tripods started out bulky and the camera, in early models, attached to the tripod by a threaded bolt; adjusting pitch or level using the legs. Over time tripods became easy to use due in part to lighter materials and collapsible, portable designs. After tripods came the monopods, table-top models, window mounts, etc.; and, in a deviant class of their own, hand held or body supported/attached camera stabilizing inventions. It is this category camera mounting apparatus I will focus on in Prior Technology.

Another aspect of making all tripods easier to use was the tripod mounting surface itself, built for adjustability of the camera orientation. This adjustability evolved to, in some cases, a universal ball-head (or tripod type head) that was a separate a unit from the tripod. At present, a large variety of support & stabilization devices as well as ball-head devices are on the market and they are extensively interchangeable; plus, this standardized compatibility extends to the camera and other instruments as well.

Inventions that are compact and utilize shoulder support and/or stabilization go back at least fifty years, as the Tolcher (U.S. Pat. No. 2,712,779) provides top of shoulder support and stabilization, forward handle, and slide attachment thus dividing the weight of the equipment between shoulder and forward grip.

Kardach (U.S. Pat. No. 5,612,756) improves on Tocher's design by providing top of shoulder support and stabilization, forward handle, and slide attachment plus allowing the apparatus to fold in half.

Assel (U.S. Pat. No. D302,171) provides essentially the same features as the previous two inventions with less parts; a frame bent and formed from a single material, a no-slide material on the attachment surface, plus foam padding for the grip and shoulder surface.

Aratani (U.S. Pat. No. 5,305,034) details an apparatus for camera stabilization that utilizes one support arm terminating in a horizontal shoulder position for stabilization on one end with a single mount surface at the other. Orientation of this apparatus however is not clear.

Hanke (U.S. Pat. No. D276,620) details apparatus of tubular construction. It has telescopic adjustment with horizontal shoulder position for stabilization that terminates to a single mount surface, complete with mount device.

Apparatus with top of shoulder support and stabilization of a camera, Reppert (U.S. Pat. No. D345,573) details an apparatus of tubular construction, it telescopes for adjustment plus the forward piece pivots perpendicular to the shoulder piece. It utilizes a single attach point.

Emerson (U.S. Pat. No. D270,734) details apparatus for camera stabilization of simple construction. Wherein the single support arm, with one end at shoulder, then terminating at a single mount surface. Adjustability is obtained from apparatus positioning only.

Lastly, is a camera mounting and stabilization device is shown in the United States Patent to Campbell (U.S. Pat. No. 5,424,791) wherein several attachment mounting surfaces are provided at the instrument end. The opposite end of the apparatus terminates in a curved butt plate, as a receiver for the horizontal shoulder position. This apparatus has specific plates for providing and reinforcing mounting surfaces. The apparatus, once drawn to the shoulder, steadies and supports camera and equipment.

Deficiencies in Prior Technology

Tolcher's (U.S. Pat. No. 2,712,779) apparatus may too large to be practical for smaller cameras and instruments, it is complex and expensive to manufacture, it consists of multiple parts, lacks multiple mounting surfaces, utilizes or otherwise requires a forward handle, and it lacks a one piece design to facilitate mass production.

Kardach's (U.S. Pat. No. 5,612,756) apparatus is also complex and expensive to manufacture, consisting of multiple parts, it utilizes or otherwise requires a forward handle, and lacks a one piece design to facilitate mass production.

Assel's (U.S. Pat. No. D302,171) apparatus consists of multiple parts, lacks multiple mounting surfaces, and lacks a one piece design to facilitate mass production.

Aratani's (U.S. Pat. No. 5,305,034) apparatus is complex and expensive to manufacture, consisting of multiple parts and lacking multiple mounting surfaces; it lacks adjustability, and it lacks a one piece design to facilitate mass production.

Hanke's (U.S. Pat. No. D276,620) invention is complex and expensive to manufacture, consisting of multiple parts, lacking multiple mounting surfaces, and will not receive a universal ball head; it lacks top of shoulder support, and it lacks a one piece design to facilitate mass production.

Reppert's (U.S. Pat. No. D345,573) apparatus consists of multiple parts, lacks multiple mounting surfaces, and lacks a one piece design to facilitate mass production.

The apparatus Emerson (U.S. Pat. No. D270,734) details consists of multiple parts, lacks multiple mounting surfaces, lacks adjustability, lacks top of shoulder support, and lacks a one piece design to facilitate mass production.

Finally, even in Campbell's (U.S. Pat. No. 5,424,791) invention, we see it is complex to manufacture, it consists of multiple parts, and lacks a one piece design to facilitate mass production.

Summarizing the Prior Technologies Overall Deficiencies:

The main flaw, form the perspective of this new invention, is not that they lack functionality, but that they are not designed to make the most of modern manufacturing techniques; facilitating low cost mass production and mass marketing.

Another flaw in the prior technology are designs that tend to stabilize more than they support, as the shoulder interface butt curve rests against the front of the shoulder, more like the operation of a rifle. Of those designs that do provide top of shoulder support, the overall position of the apparatus is still horizontal, shifting less weight than possible to the shoulder had the various apparatus been designed with a slight upward angle (from the shoulder to the instrument mounting surface).

Also, the prior technology lacks the vision of a simple apparatus designed to work with the diverse range of compact, hand-held instrumentation currently available as well as with future designs.

And last, inventions that provided utmost support and stabilization were not included because they either had to be worn, they were bulky, or both. And therefore, were in a class of function and usability separate from the specific designs noted herein.

### BRIEF SUMMARY OF THE INVENTION

The primary object of the invention is to provide a simple apparatus for quick stabilization and support of a camera; or video camera, scope, binocular, monocular, night vision scopes.
Another object of the invention is to provide support, mitigating arm and shoulder fatigue.
Another object of the invention is to provide an apparatus that is easy to use.
Another object of the invention is to provide an apparatus that is inexpensive to manufacture.
Another object of the invention is to provide an apparatus that is light weight, small, and portable.
A further object of the invention is to provide stabilization while walking, standing, sitting, or kneeling.
Yet another object of the invention is to improve the quality of the photograph, movie, viewing, or targeting experience.
Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a simple apparatus for the quick support and stabilization a camera or similar instrument comprising: compact, durable, lightweight frame, with a comfortable ergonomic shape, that is inexpensive to manufacture; the butt curve of the apparatus rests against and slightly on top shoulder, mitigating arm fatigue using the main position; the apparatus also includes multiple apertures and surfaces for mounting instruments, augmenting versatility and adjustability; instrument attaches directly to the apparatus, or via secondary devices such as universal ball heads, between the instrument and the apparatus; it is the versatility and inexpensive one piece construction that make this apparatus an ideal mass marketing device for universal ball heads, notwithstanding the fact that an instrument may mount directly to the apparatus; no other camera support and stabilization apparatus incorporates the above listed functions as efficiently or simply.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 illustrates a plan view of the apparatus

FIG. 2 shows a perspective of the apparatus

FIG. 2B shows a perspective of the part of apparatus

FIG. 3 illustrates a side view with human torso of the apparatus in assembly with other devices

FIG. 3B shows a side view with human torso of the apparatus in assembly

FIG. 3C illustrates a plan view of the apparatus of the apparatus in assembly

FIG. 3D illustrates a plan view of the apparatus of the apparatus in assembly

FIG. 3E illustrates a perspective view of part of the apparatus in assembly

FIG. 3F illustrates a plan view of the apparatus of the apparatus in assembly

FIG. 4 illustrates a plan view with an alternate embodiment of the apparatus

FIG. 5 illustrates a plan view with another alternate embodiment of the apparatus

FIG. 6 illustrates a plan view with yet another alternate embodiment of the apparatus

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

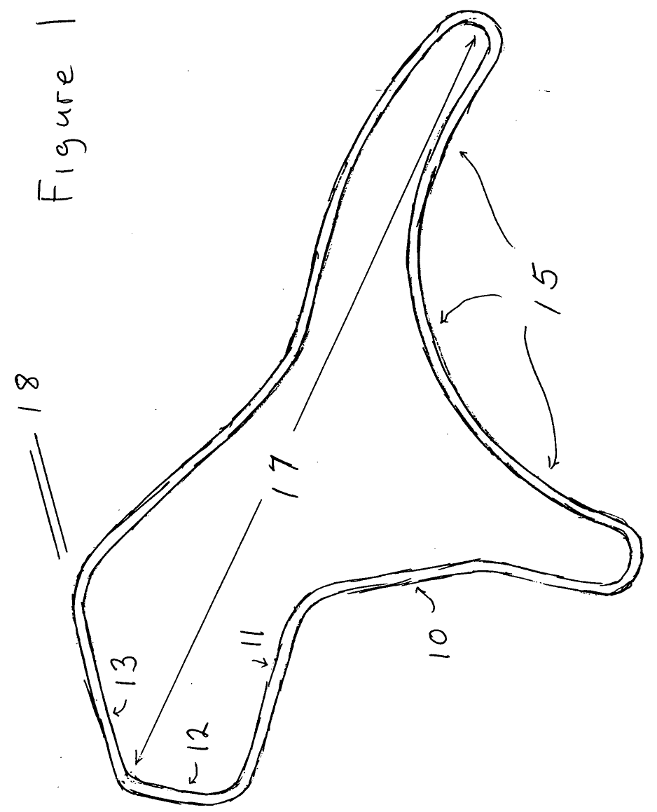

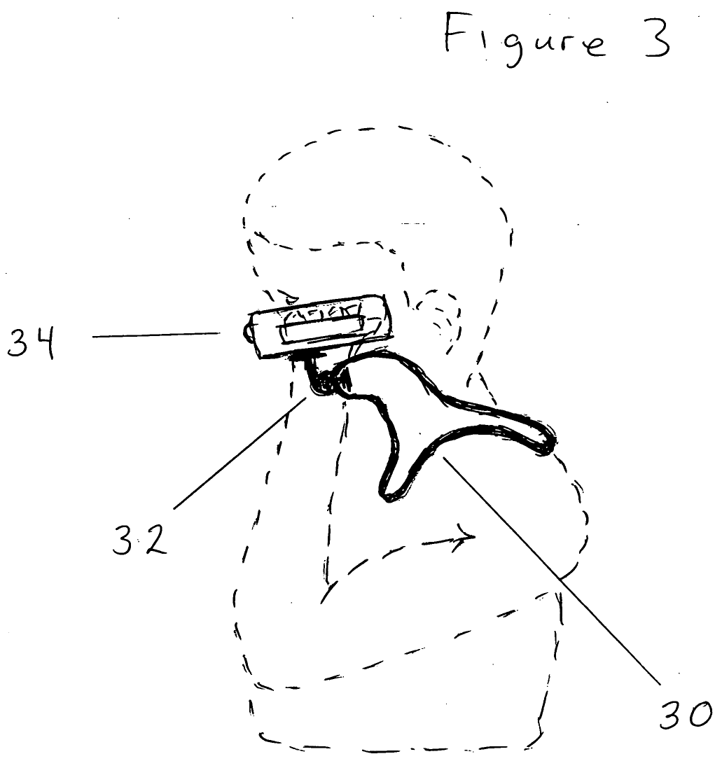

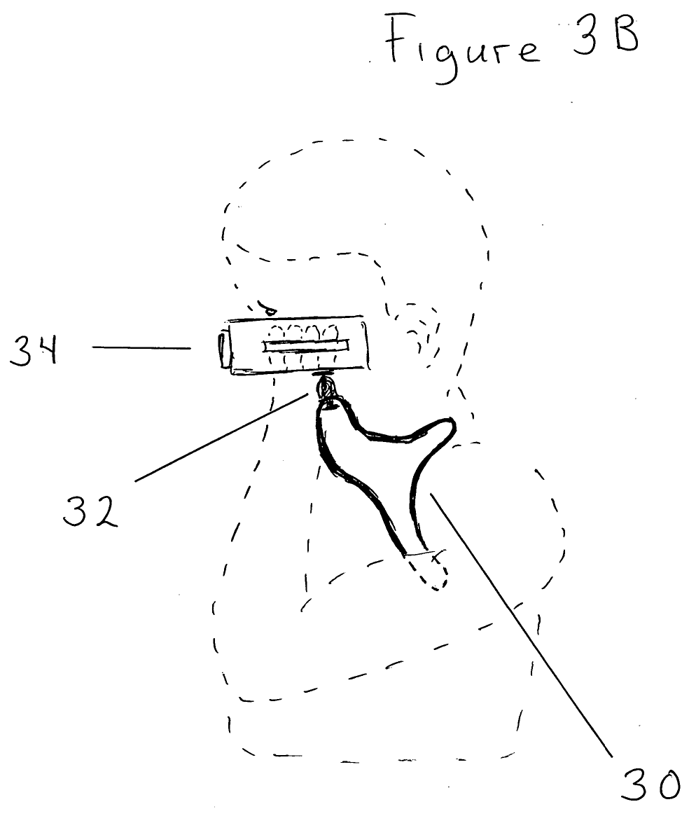

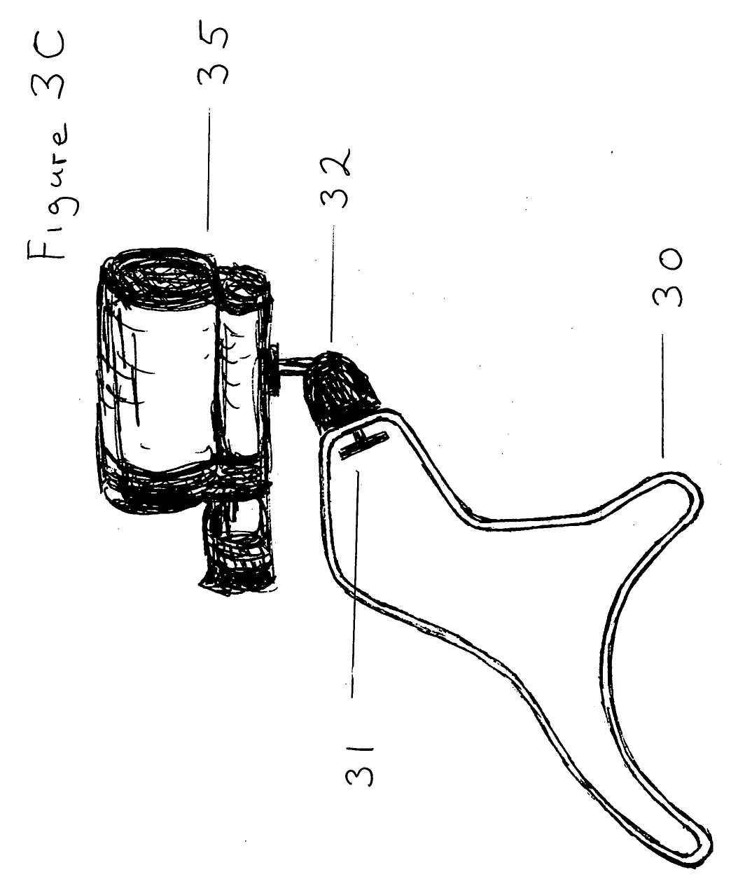

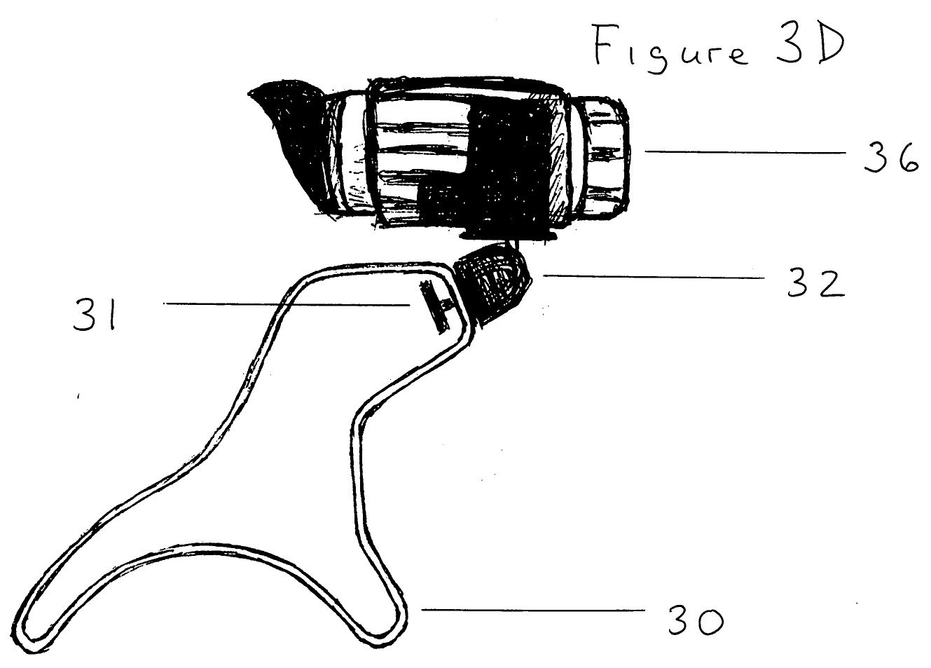

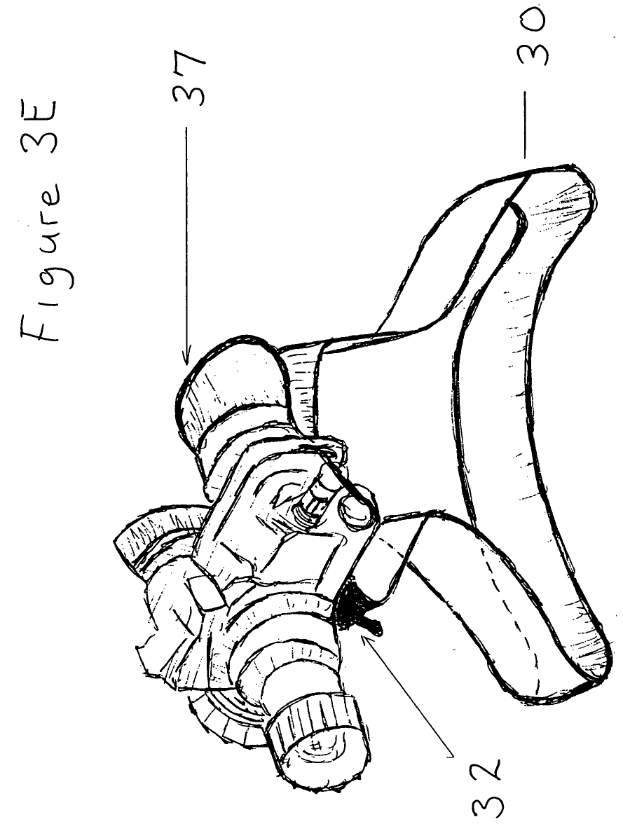

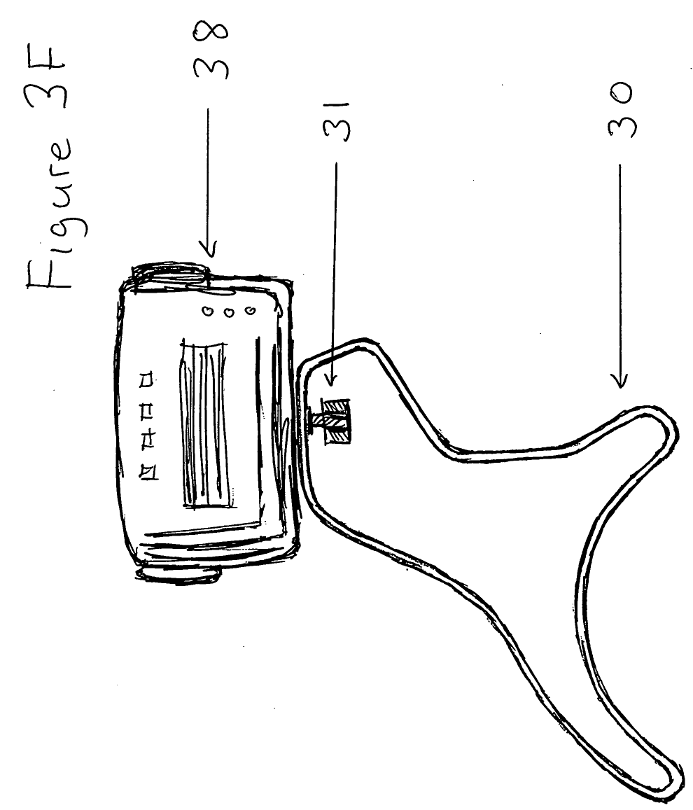

FIG. 1 shows a plan view of the apparatus; detail 10 as the vertical support (top of shoulder position, see FIG. 3); details 11, 12, 13 are mount surfaces; detail 15 is the butt curve; detail 17 measures approximately ten inches overall length; and detail 18 indicates the approximately 0.125 inch wall thickness. One alternate embodiment of the apparatus utilizes thicker and wider mounting surfaces, providing increased strength and surface area for larger devices and instruments.

FIG. 1 also best illustrates the simple one piece design that can be injection molded or extruded; with the former complete with apertures, or the later requiring further machining. A variety of processes and materials may be used to manufacture the apparatus making it inexpensive to mass produce, lightweight, and durable without departing from my invention. In the preferred embodiment the apparatus is manufactured by injected molding using glass reinforced nylon; however, the invention is not necessarily limited to that specific embodiment.

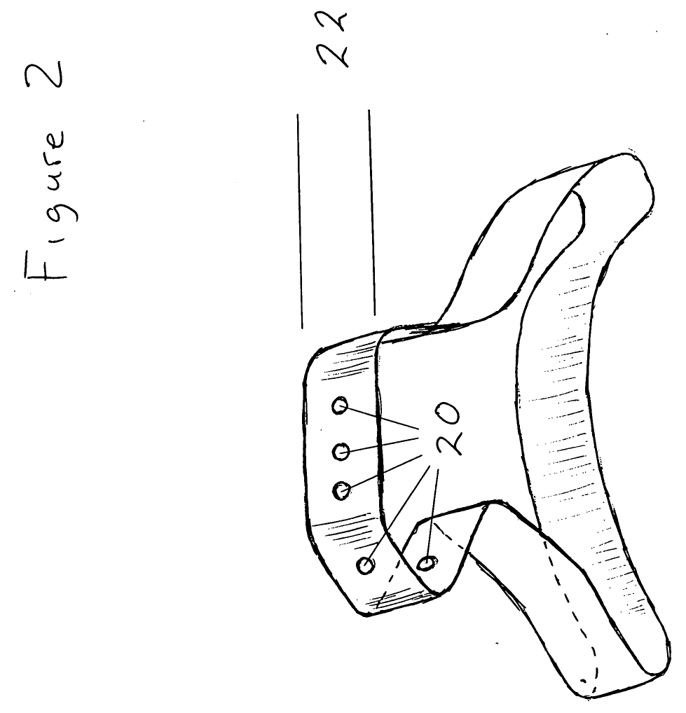

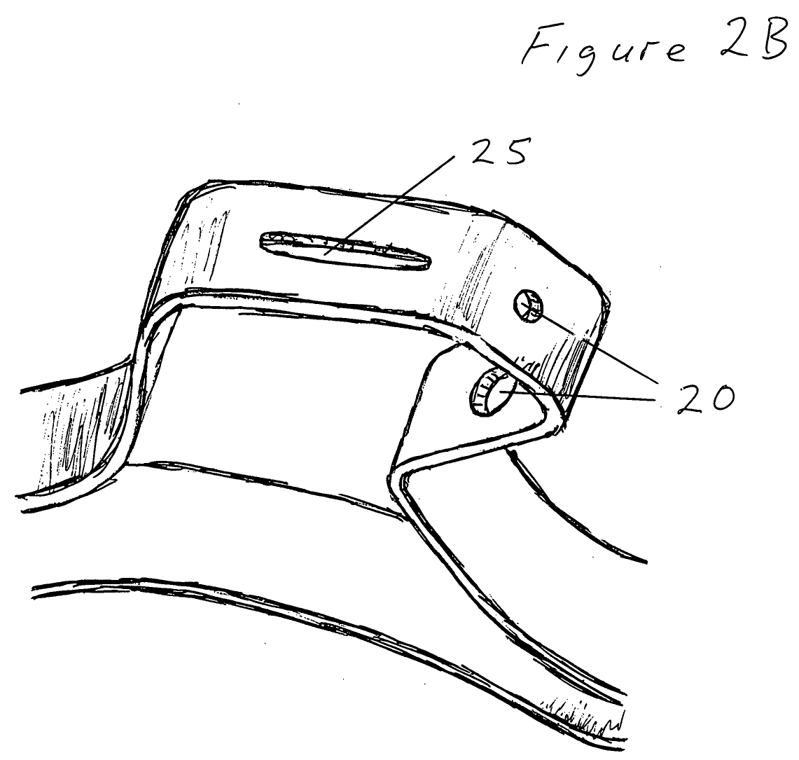

FIG. 2 shows a perspective of the apparatus with circular apertures on multiple mount surfaces; detail 20 illustrates circular apertures; and detail 22 indicates the approximately 1 inch width. Each surface and aperture provides alternate positioning and/or added devices.

FIG. 2B shows a perspective of the part of apparatus, again with multiple apertures; detail 25 illustrates a slotted aperture for an alternate embodiment; and detail 20 illustrates circular apertures. Utilizing an embodiment with slotted apertures further adds adjustability to the apparatus.

FIG. 3 illustrates a side view with human torso of the apparatus in assembly with a universal ball-head and instrument; detail 30 illustrates the apparatus; detail 32 illustrates the universal ball-head; and detail 34 representing the instrument. In accordance with an important feature of the present invention, there is shown in FIG. 3 the apparatus in the main support and stabilizing position. In this position, the butt curve rests against and slightly on top of the right or left shoulder. Thus, weight from the assembly is shifted to the shoulder. This position can be deployed quickly and represents maximum support and adjustability providing ambidextrous stability while standing, sitting, or walking.

FIG. 3B shows a side view with human torso of the apparatus in assembly with a universal ball-head and instrument; detail 30 illustrates the apparatus; detail 32 illustrates the universal ball-head; and detail 34 representing the instrument. In this position, the butt curve rests against the right or left shoulder and curving under the arm; partially between the arm and body. Note that the inverted position changes the relative position of the mounting surfaces; an augmentation of adjustability. FIG. 3B demonstrates the versatility of the comfortable, ergonomic design emphasizing one possible alternate position.

FIG. 3C illustrates a plan view of the apparatus of the apparatus in assembly with a universal ball-head and spotting scope; detail 30 illustrates the apparatus; detail 31 illustrates a screwing type connection; detail 32 illustrates the universal ball-head; and detail 35 represents a spotting scope. In this illustration the scope is attached via ball-head device but could be attached directly, allowing for various scopes and the final adjustment. FIGS. 3C through 3F further demonstrate how this apparatus incorporates multiple functions efficiently, in a compact, portable design.

FIG. 3D illustrates a plan view of the apparatus of the apparatus in assembly with a universal ball-head and scope; detail 30 illustrates the apparatus; detail 31 illustrates a screwing type connection; detail 32 illustrates the universal ball-head; with detail 36 representing a PVS 14 6015 Night Vision Scope. A scope may be attached through a universal ball-head or directly, allowing for various night vision instruments and final adjustment. FIG. 3D shows the angle of instrument to apparatus, suggesting a left shoulder adjustment.

FIG. 3E illustrates a perspective view of part of the apparatus in assembly with a universal ball-head and binocular; detail 30 illustrates the apparatus; detail 32 locates the universal ball-head, mostly hidden in this view; with detail 37 representing a PVS 7D Military Issue Night Vision Goggle. Binoculars and Goggles may be attached to the apparatus through universal ball-heads or various vertical binocular mounts adding stability as well as support during extended use.

FIG. 3F illustrates a plan view of the apparatus in assembly with a digital video camera; detail 30 illustrates the apparatus; detail 31 illustrates a screwing type connection; and detail 38 represents a digital video camera. This view further demonstrates the versatility of the apparatus by mounting an instrument directly to the apparatus with no intermediate device. The screw-type connection is also an adjustment, where the particular embodiment of the apparatus utilizes a slotted aperture. The apparatus will mitigate the fatigue of recording by providing support whether attached directly or through an intermediate device such as a universal ball-head.

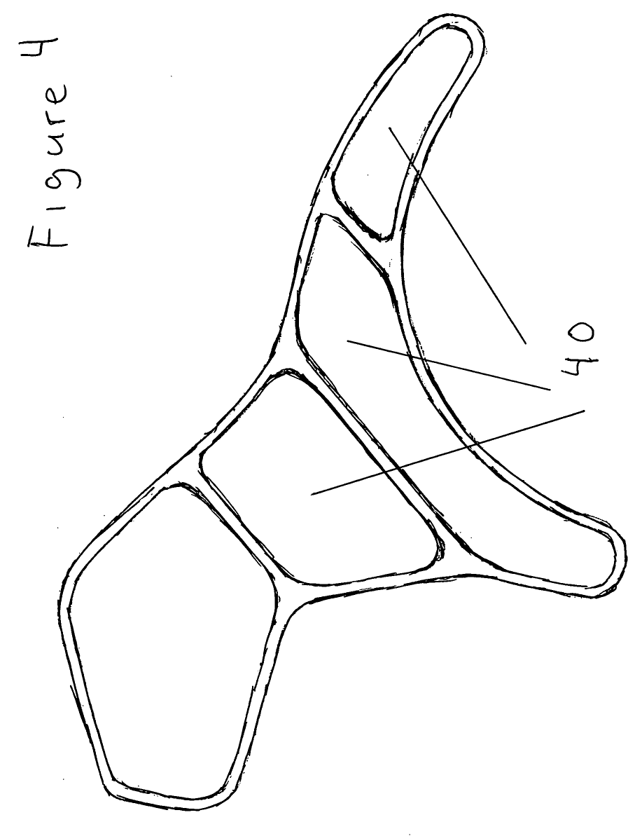

Turning to FIG. 4, a plan view is shown with an alternate embodiment of the apparatus; detail 40 shows compartments containing storage spaces to take advantage of the void created by the shape of the frame.

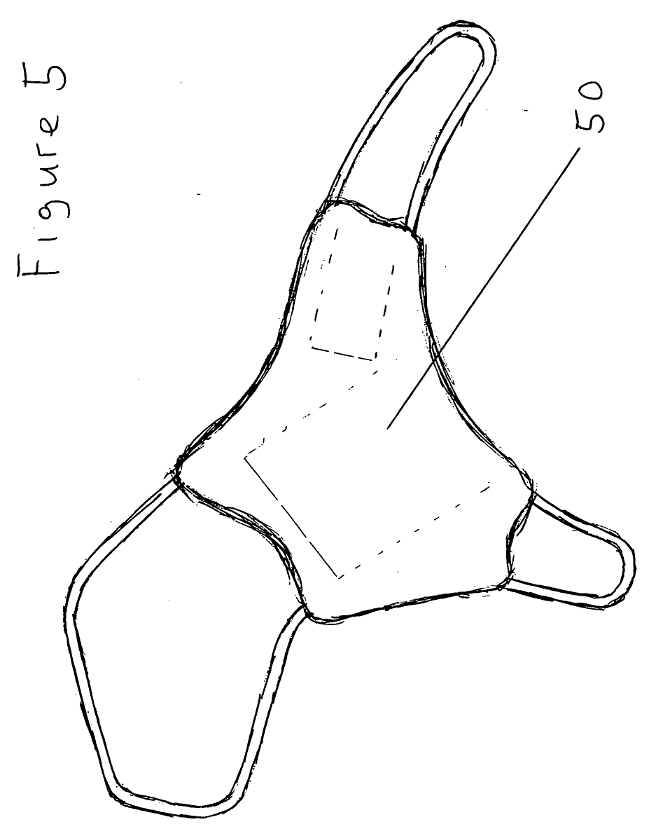

FIG. 5 is a plan view of another alternate embodiment of the apparatus; it is shown with a material or fabric covering, detail 50, containing pockets to take advantage of the void created by the shape of the frame.

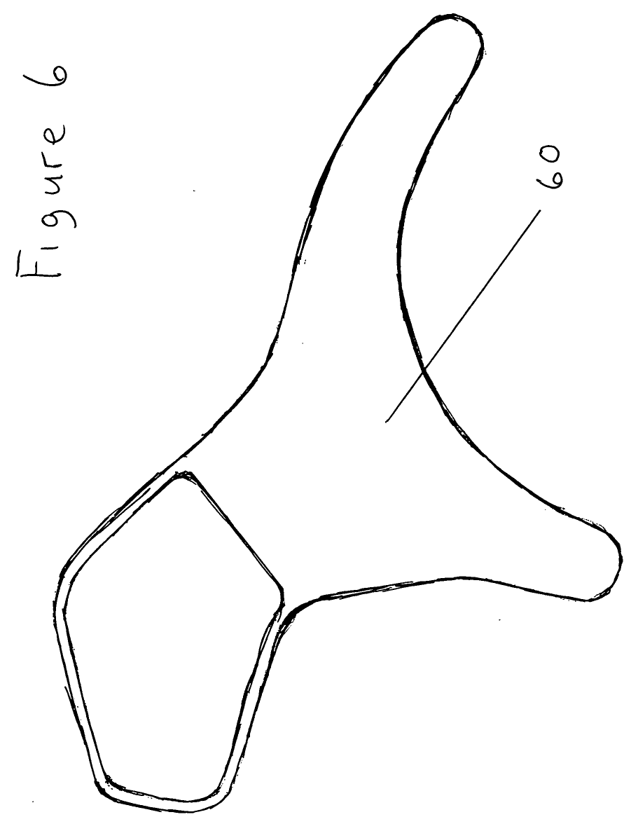

In yet another embodiment, the FIG. 6 shows a plan view of the apparatus; showing most of the frame encapsulated, to make the apparatus buoyant.

While this invention has illustrated several embodiments, this description is not to be construed in a limiting sense. FIGS. 3 and 3B demonstrate two possible positions for the apparatus during use, whereas FIGS. 3C, 3D, 3E, and 3F demonstrate four possible assembly configurations using different instruments and FIGS. 4, 5 and 6 demonstrate practical exploitations of the void created by the simple shape. Apart from the universal ball-head or various instruments illustrated, other equipment may be attached with the invention; and various modifications and combinations of the illustrative embodiments as well as other embodiments will be apparent to those skilled in the art upon referencing this disclosure. It is therefore intended that this disclosure encompass any such modifications, combinations or embodiments.

What is claimed is:

1. A simple apparatus quickly supporting and stabilizing a camera or similar instruments comprising:
compact, durable, lightweight frame;
comfortable, ergonomic shape;
inexpensive to manufacture and mass produce;
butt curve rests against and slightly on top shoulder, mitigating arm fatigue using normal position;
multiple apertures and surfaces to mount equipment for versatility and adjustability;
attach instruments directly to apparatus; or
attach universal ball-head to apparatus, between instrument and apparatus; and
no other camera stabilizing apparatus incorporates the above listed functions as efficiently or simply.

2. An apparatus for securing and stabilizing a camera or similar instruments as claimed in claim 1 further comprising an ambidextrous shape, for use right or left handed.

3. An apparatus for securing and stabilizing a camera or similar instruments as claimed in claim 1 further comprising a design that allows for alternate positioning; when inverted, the butt curve rests against shoulder curving under arm; and, when vertical, the butt curve rests on knee or other surface.
